(19) United States
(12) Patent Application Publication
(10) Pub. No.: US 2025/0270709 A1
(43) Pub. Date: Aug. 28, 2025

(54) HYBRID TOOL ASSEMBLY FOR PIPELINE DESCALING

(71) Applicant: Saudi Arabian Oil Company, Dhahran (SA)

(72) Inventor: Sameeh Batarseh, Dhahran (SA)

(21) Appl. No.: 18/588,246

(22) Filed: Feb. 27, 2024

(51) Int. Cl. C23G 3/04

(52) U.S. Cl. CPC C23G 3/04

(57) ABSTRACT

Devices and methods for descaling a pipeline utilizing a hybrid tool assembly are provided. The hybrid tool assembly includes an assembly head body which includes a bottom surface connected to the circumferential surface. The bottom surface defines an acid jetting opening, a water jetting opening, a gas purge opening and a laser opening. An acid jetting subassembly is fluidically coupled to the acid jetting opening and configured to jet acid onto the scales. A water jetting subassembly is fluidically coupled to the water jetting opening and configured to jet water. A gas purge subassembly is fluidically coupled to the gas purge opening and configured to purge gas. A laser subassembly is functionally coupled to the laser opening and configured to generate a laser beam. The gas purge subassembly is configured to operate together with at least one of the acid jetting subassembly, the water jetting subassembly or the laser subassembly.

### TECHNICAL FIELD

The present disclosure relates to pipeline descaling.

### BACKGROUND

In the oil and gas industry, pipelines or flowlines are used to flow fluids, e.g., hydrocarbons including petroleum, natural gas or combinations of them, between locations. In general, the pipelines are made of metals, metal alloys or similar materials that can withstand both mechanical and chemical effects of the fluids flowed through the pipeline. Nevertheless, over time, the operating conditions within the pipeline or the properties of the fluids flowed through the pipelines can cause scaling within the pipeline. Scaling is a formation of solids on an inner surface of the pipeline. Over time, the solids can extend into an inner volume of the pipeline and potentially obstruct fluid flow through the pipeline. Therefore, descaling the pipeline is an important aspect of maintaining the efficiency and integrity of pipelines.

### SUMMARY

The present disclosure describes methods, devices, systems and techniques for pipeline descaling utilizing a hybrid tool assembly.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a schematic diagram of an example pipeline system with an example tool assembly.

FIG. 1B illustrates a schematic view of an example acid jetting subassembly and an example water jetting subassembly.

FIG. 1C illustrates a schematic view of an example gas purge subassembly.

FIG. 1D illustrates a schematic view of an example laser subassembly.

FIG. 1E illustrates a schematic view of an example rotator subassembly.

FIGS. 2A-2C illustrates example bottom surfaces of an assembly head body.

FIG. 3 illustrates an example assembly head body with an elongated gas purge nozzle.

FIG. 4 is a flow chart of an example process to descale a pipeline.

It is to be understood that the various exemplary implementations shown in the figures are merely illustrative representations and are not necessarily drawn to scale.

### DETAILED DESCRIPTION

In the oil and gas industry, scales are formed as a result of the precipitation of minerals and other solid deposits from the fluids that flow through wells, pipelines, and production facilities. The scales can include calcium carbonate, calcium sulfate, barium sulfate, strontium sulfate, sodium chloride, or any mixture thereof. The formation of scales can be influenced by various factors including pressure, temperature, chemical composition of the fluids, and geological conditions. For example, calcite is formed when the pressure and temperature decrease as fluids flow up the well. Barite is formed when barium ions in the formation water combine with sulfate ions from the oil or gas. Methods to remove scales include employment of explosives to break down scale, especially for brittle scale. Introducing chemical inhibitors into the fluid stream is another method to hinder scale formation by modifying the crystal structure of the minerals responsible for scale formation.

This disclosure describes utilizing a hybrid tool assembly for descaling pipelines. In the context of this disclosure, hybrid refers to a comprehensive approach that combines multiple descaling techniques within a single tool assembly, including laser descaling, acid jetting, water jetting and gas purging. A hybrid tool assembly means a tool assembly that incorporates subassemblies for each of these descaling methods. In some aspects, the hybrid tool assembly includes an assembly head body which includes a bottom surface. The bottom surface defines an acid jetting opening, a water jetting opening, a gas purge opening and a laser opening. The openings are endpoints of internal flow pathways that are at least partially located within the assembly head body. The pathways are channels or conduits configured to guide the flow of various fluids through the assembly head body. An acid jetting subassembly is fluidically coupled to the acid jetting opening. The acid jetting subassembly is configured to jet acid out of the assembly head body through the acid jetting opening onto target scales. A water jetting subassembly is fluidically coupled to the water jetting opening and configured to jet water out of the assembly head body through the water jetting opening onto the target scales. A gas purge subassembly is fluidically coupled to the gas purge opening and configured to purge gas out of the assembly head body through the gas purge opening. A laser subassembly is functionally coupled to the laser opening and configured to generate a laser beam passing through the laser opening onto the target scales. The gas purge subassembly is configured to operate together with at least one of the acid jetting subassembly, the water jetting subassembly or the laser subassembly to descale the pipeline.

Implementations of the present disclosure can provide one or more of the following technical advantages. For example, the techniques described here integrate various descaling methods, e.g., acid jetting, water jetting, gas purging, and/or laser descaling, to descale a pipeline into a single assembly head body. These hybrid techniques provide a more effective approach for the removal of different types of scale deposits on inner surfaces of the pipeline. The selection of descaling methods can depend on the composition or natures of the scales. For instance, acids can be used to remove calcium carbon scales. Water jetting can flush bulky scales out of the pipeline. The laser beam can melt or break down scales. By integrating multiple techniques, it becomes possible to descale various types of scales in a single operation using a single tool. These descaling techniques can also address the risk of acid corrosion in pipes by injecting water and acid during operation simultaneously. In addition, gas purging is employed to clear the path by removing cuttings and debris. This not only enhances the efficiency of laser descaling by reducing energy waste absorbed by debris but also protects the laser subassembly from potential damage caused by debris and cuttings. Further, laser descaling doesn't impact the integrity of pipelines, as it is a non-contact method that selectively targets the scale while leaving the underlying pipeline material largely unaffected. This hybrid descaling method reduces manpower requirement and shortens descaling operation time. Additionally, the hybrid tool assembly can be enclosed which is environmentally friendly.

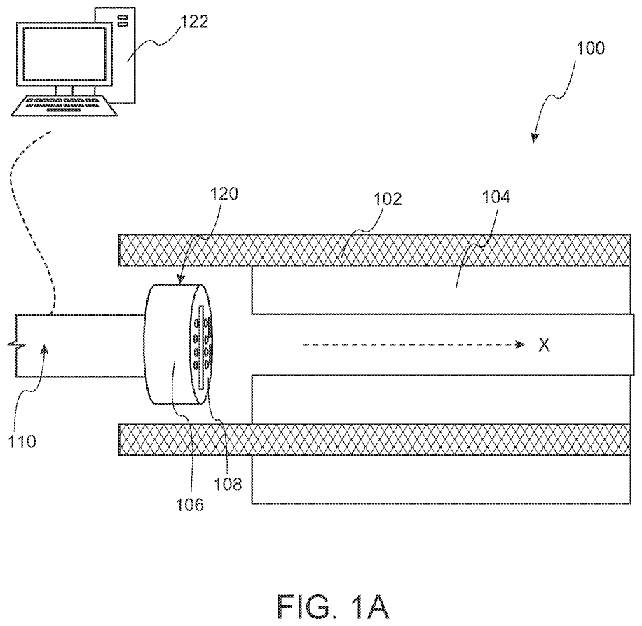

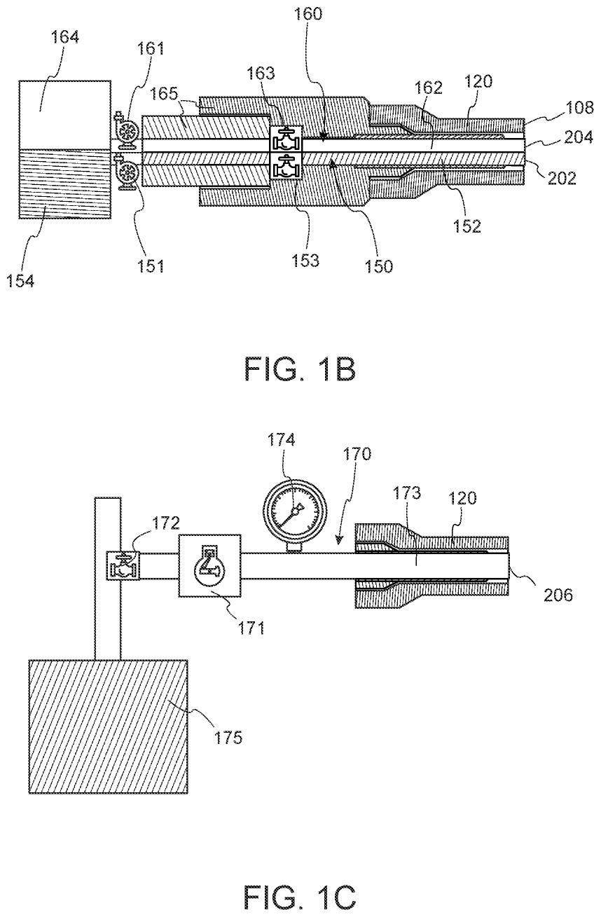

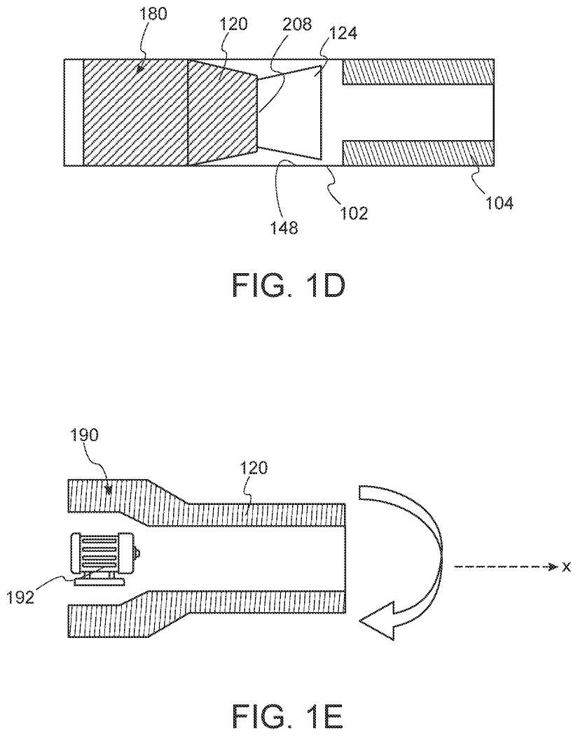

FIG. 1A illustrates a schematic diagram of an example pipeline system 100 with an example hybrid tool assembly 110. The well pipeline system 100 includes a pipeline 102 (or flowline), which is used to flow fluids, e.g., hydrocarbons including petroleum, natural gas or combinations of them, between locations. The pipeline 102 can be positioned above or below the surface of the Earth. In general, the pipelines 102 can be made of metals, metal alloys or similar materials that can withstand both mechanical and chemical effects of the fluids flowed through the pipeline 102. Pipelines 102 can accumulate scales 104 on inner surfaces due to the deposition of various substances present in the fluid being transported. These substances may include minerals, salts, corrosion by-products, organic matter, or other impurities carried by the fluid. Over time, these materials adhere to the inner surface of the pipeline 102, forming layers of scale 104. Factors such as temperature, pressure, flow rate, and the composition of the transported fluid can influence the rate and composition of scale accumulation. The accumulation of scales 104 in pipelines 102 can have several adverse effects. For example, it can reduce the internal diameter of the pipeline, leading to flow restrictions, increased pressure drop, or even pipeline blockage. In addition, scales 104 can create rough surfaces that promote corrosion and erosion of the pipeline material, compromising its structural integrity over time.

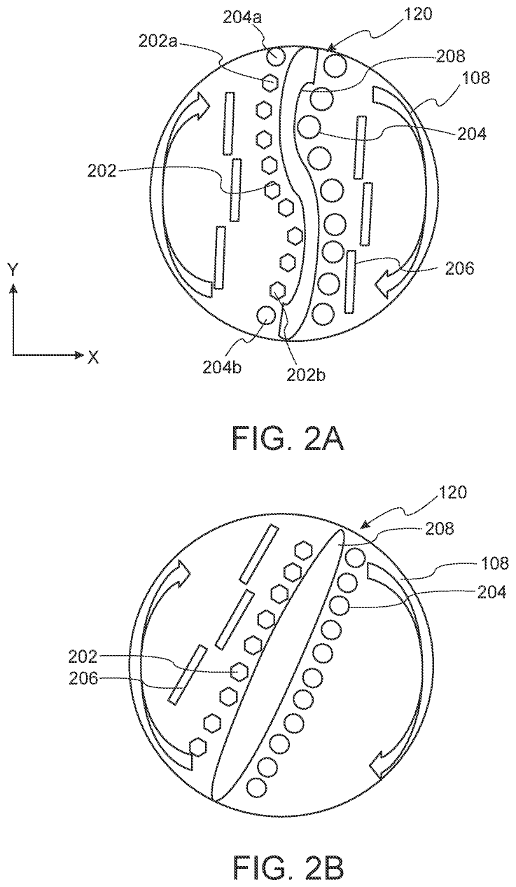

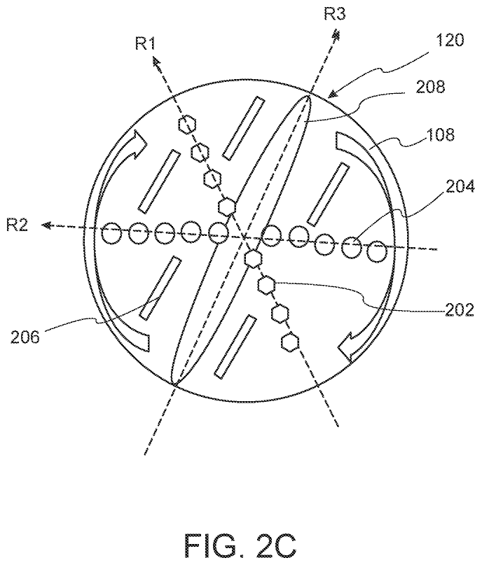

The hybrid tool assembly 110 described here is configured to descale the pipeline 102. The hybrid tool assembly 110 includes an assembly head body 120. The assembly head body 120 includes a circumferential surface 106 and a bottom surface 108 connected to the circumferential surface 106. The bottom surface 108 defines at least one acid jetting opening, at least one water jetting opening, at least one gas purge opening and at least one laser opening, as described with further details in FIGS. 2A-2C. In some implementations, the assembly head body 120 can have a cylindrical shape or a frusto-conical shape with a bottom surface 108. The circumferential surface 106 and bottom surface 108 can be made of steel, aluminum, composite material, titanium, or any other suitable materials.

The hybrid tool assembly 110 includes an acid jetting subassembly 150. FIG. 1B illustrates a schematic view of an example acid jetting subassembly 150 and an example water jetting subassembly 160. The acid jetting subassembly 150 is fluidically coupled to the acid jetting opening 202. The acid jetting assembly 150 is configured to jet acid out of the assembly head body 120 through the acid jetting opening 202 onto the scales 104. The acids can chemically descale the pipelines 102 by dissolving the scales 104. In some implementations, the acids used for descaling include hydrochloric acid (HCl), hydrofluoric Acid (HF), acetic acid (CH₃COOH), citric acid (C₆H₈O₇), sulfamic acid (H₃NSO₃), phosphoric acid (H₃PO₄), or formic acid (HCOOH). Different types of scales may require specific acids for effective descaling. For examples, HCl can be used for descaling carbonate scales, e.g., calcium carbonate (limestone) or magnesium carbonate (dolomite). Chelates can remove thin layers of sulfates. HF can be effective for removing siliceous scales, e.g., silica-based deposits.

In some implementations, the acid jetting subassembly 150 includes a pump 151 which is configured to pressurize and deliver the acid to the pipeline 102. The pump ensures that the acid is propelled at the required pressure to effectively remove scales 104. Multiple tubing or conduits 152 can be connected to the acid jetting openings 202 in the assembly head body 120 to transport the acid from the pump 151 to the assembly head body 120 and jet the acid out of the assembly head body 120 through the acid jetting openings 202. Materials selected for conduits or tubing 152 used to transport acids are chosen based on their ability to withstand the corrosive nature of the acid being transported. For example, the tubing materials can include stainless steel, plastic, nickel alloys, etc. The acid jetting subassembly 150 can additionally include pressure gauge 153 configured to provide real-time monitoring of the pressure levels within the acid jetting subassembly 150 to ensure that the acid is injected at the desired pressure for effective descaling. Acids can be stored in an acid container 154. The acid container 154 can be situated in a designated area. The acids can be transferred by continuous flow through tubing or conduits 152 from their storage location to the assembly head body 120, as shown.

The hybrid tool assembly 110 further includes a water jetting subassembly 160. The water jetting subassembly 160 is fluidically coupled to the water jetting opening 204 and configured to jet water out of the assembly head body 120 through the water jetting opening 204 onto the target scales 104. The water jetting can mechanically descale the pipelines 102. For example, the water jetting subassembly 160 generates extremely high-pressure water streams, e.g., ranging from 5,000 to 40,000 pounds per square inch (psi) (34,473,800 to 275,790,400 Pascals). This high pressure can dislodge and break apart tough scales 104 within the pipelines 102. In some implementations, the water jetting chemically descales the pipelines 102. For example, halite or table salt (sodium chloride) can be effectively removed using low salinity water because it dissolves readily in water.

In some implementations, the water jetting subassembly 160 includes high-pressure pump 161, a water supply connection, and conduits or tubing 162. The high-pressure pump 161 is responsible for pressurizing water to the required levels for effective descaling. The water supply connection links the water jetting subassembly 160 to the water source, which allows the water jetting subassembly 160 to draw water from the water source. The conduits or tubing 162 is configured to transport the pressurized water to the assembly head body 120. The conduits or tubing 162 is connected with the water jetting openings 204 such that water can be jet out of the assembly head body 120 through the water jetting openings 204. In addition, a control valve 163 can be deployed in the water jetting subassembly 160 to control the flow and pressure of water as needed. Water can be stored in a water container 164. The water container 164 can be situated either within the assembly head body 120 or in another designated area. In the latter case, the water can be transferred through tubing or conduits 162 from their storage location to the assembly head body 120. In some implementations, the acid jetting subassembly 150 and the water jetting subassembly 160 are positioned at least partially within a same housing 165. In some implementations, fluids other than water and acid can be pumped in a similar manner to the assembly head body for descaling purposes.

The hybrid tool assembly 110 further includes a gas purge subassembly 170. FIG. 1C illustrates a schematic view of an example gas purge subassembly 170. The gas purge subassembly 170 is fluidically coupled to the gas purge opening 206 and configured to purge gas out of the assembly head body 120 through the gas purge opening 206. The gas can be pressurized air or nitrogen. The pressurized gas can clear the path for water, acids, and/or laser beam by removing debris or cutting away from the targeted scales area. In some implementations, the gas purge subassembly 170 includes a compressor 171, gas purge valve 172, gas purge lines or tubing 173, and a pressure regulator 174. The compressor 171 compresses gas, e.g., air or nitrogen, to increase its pressure to a desired level. The gas purge valve 172 controls the flow of gas through the subassembly. Gas purge lines or tubing 173 are configured to carry the purged gas from the gas source 175 to the assembly head body 120. The end of gas purge lines 173 is connected to the gas purge openings 206 at the bottom surface 108 of the assembly head body 120 such that the gas can be purged out of assembly head body 120 through the gas purge openings 206. The gas purge lines 173 can be configured to withstand the conditions and pressures associated with the purging process. The pressure regulator 174 can be configured to maintain a controlled and safe pressure level within the gas purge subassembly 170 and ensure that the gas is expelled at the desired pressure. When the gas purge valve 172 is opened, gas flows from the gas source 175 to the compressor 171 for compression. The pressurized gas then flows to the assembly head body 120 through the gas purge lines 173. The pressure of the gas can be controlled by the pressure regulator 174. The pressurized gas is subsequently directed to a designated location through the gas purge opening 206 for clearing the debris or cuttings in the pipeline 102.

The hybrid tool assembly 110 further includes a laser subassembly 180. FIG. 1D illustrates a schematic view of an example laser subassembly 180. The laser subassembly 180 is functionally coupled to the laser opening 208 and configured to generate a laser beam 124 passing through the laser opening 208 onto the target scales 104. The laser beam 124 can thermally descale the pipelines 102. The laser beam 124 can be precisely directed towards specific areas where scales 104 have accumulated. The intense heat generated by the laser can dissolve, break down, or melt scales 104, turning them into smaller particles or gas. These small pieces of scales 104 can be easily flushed out of the pipeline 102 by water jetting. High power laser beam, e.g., with power greater than 2 Kilowatts (kW), can be utilized. In some implementations, compact lasers with a laser beam delivery system is included in the laser subassembly 180. In some implementations, the laser subassembly 180 utilizes a laser diode to generate laser beam 124.

In some implementations, an aperture is positioned in the laser opening on the bottom surface 108 of the assembly head body 120 to enable the passage of the laser beam 124 through the bottom surface 108. In some implementations, the laser subassembly 180 includes a laser source, a focusing optics, a beam delivery system and a control system. The laser source generates the laser beam 124. Focusing optics concentrate and shape the laser beam 124 to achieve the desired intensity and shape. The focused laser beam 124 is then directed towards the scales 104. As shown, a laser beam 124 is emitted towards target scales 104 accumulated at the inner surfaces of the pipeline 102. The scales 104 inside the pipeline 102 can be thick, substantially reducing the internal diameter of the pipeline. Thus, the laser beam 124 can be directed towards the lateral surfaces of the target scales 104 to effectively remove them.

In some implementations, the laser beam 124 has selectivity over targeted materials. Different materials absorb laser energy differently based on their properties. The laser subassembly 180 can be configured to target specific materials (e.g., scale materials) while leaving others (e.g., pipeline materials) unaffected. As such, the laser beam 124 allows for targeted descaling without causing damage to the pipeline infrastructure. In some implementations, the laser beam 124 can be split into multiple arrays via high power beam splitters installation. The high-power beam splitters can be configured to divide a laser beam 124 into two or more beams to transmit the laser beam 124 on larger areas of the scales 104. In some implementations, a beam expander can be utilized in conjunction with the beam splitters. The beam expander is configured to increase the diameter and change the shape of the laser beam 124, e.g., from a spot size shape to an elongated shape. In some implementations, the hybrid tool assembly 110 includes a fiber optic cable which is configured to transport energy from an energy source located at a surface of the Earth to the laser subassembly 180. The energy can be either electrical power or optical energy.

In some implementations, the hybrid tool assembly 110 includes a rotator subassembly 190. FIG. 1E illustrates a schematic view of an example rotator subassembly 190. The rotator subassembly 190 is configured to rotate the assembly head body 120 along an axial axis, e.g., X direction in FIG. 1E. The rotator subassembly can include an electric motor 192 connected to the assembly head body 120, providing power for the rotation. In some implementations, the rotator subassembly 190 is configured to operate simultaneously with at least one of the acid jetting subassembly 150, the water jetting subassembly 160, the gas purge subassembly 170, or the laser subassembly 180. In other words, the assembly head body 120 rotates whenever any of the acid jetting, water jetting, gas purging, or laser descaling are functioning. Rotational movement generates centrifugal force, facilitating the splashing of fluid, e.g., gas or water, onto the scales 104, enhancing the efficiency of the descaling process. Moreover, the rotating assembly head body 120 can convert a linear laser beam 124 into a circular-shaped one. The circular-shaped laser beam 124 can cover a larger area of the scales 104 and offer more uniform descaling treatment across the scales 104.

The gas purge subassembly 170 is configured to operate together with at least one of the acid jetting subassembly 150, the water jetting subassembly 160 or the laser subassembly 180 to descale the pipeline 102. The gas purge subassembly 170 can work simultaneously or sequentially with any other subassemblies. In some implementations, the gas purge subassembly 170 operates sequentially with the acid jetting subassembly 150 and the water jetting subassembly 160. The gas purge subassembly 170 can be deployed first to clear cuttings and debris on targeted scales 104. The acid jetting subassembly 150 and the water jetting subassembly 160 are subsequently deployed to erode, dissolve and/or flush out the targeted scales 104. In some implementations, the gas purge subassembly 170 operates simultaneously or sequentially with the laser assembly. The gas purge subassembly 170 clears the pathway for the laser beam 124 by removing debris. The laser subassembly 180 emits a laser towards target scales 104 to break down or dissolve the scales 104.

In some implementations, any two of the subassemblies can work simultaneously. In some implementations, the acid jetting subassembly 150 and the water jetting subassembly 160 are operated simultaneously to reduce the acid concentration in the mixture of the fluids and mitigate the risk of pipeline corrosion. In some implementations, the laser subassembly 180 operates simultaneously with the acid jetting subassembly 150 and the water jetting subassembly 160. The laser beam 124 is utilized to thermally weaken or break down the descales 104. Meanwhile, the acid erodes the scales 104 into small fragments, and the water flushes the fragmented scales 104 out of the pipeline 102. In some implementations, when the scales 104 block the inner space of pipelines 102, the laser beam 124 can be utilized first to create a pathway for the acid by at least partially penetrating the scales 104 or breaking down a portion of the scales 104. Subsequently, the acid jetting assembly is activated to jet acids on the scales 104. Because of the preceding laser treatment, there is an expanded contact area for acid erosion, thus enhancing the efficiency of the descaling process.

The selection of descaling methods, e.g., thermal, chemical and/or mechanical, can depend on the composition and nature of the scales 104. In some implementations, if the scales 104 include calcium carbonate (CaCO₃), a combination of laser treatment, acid erosion, and water jetting can be deployed for descaling. Acid can react with the calcium carbonate to form soluble compounds, facilitating its removal. In some implementations, if the scales 104 include iron sulfide deposits that are resistant to acid dissolution, the laser subassembly 180 and the water jetting subassembly 160 can be utilized to remove the scales. This tailored approach ensures that suitable methods are employed based on the types of the scales encountered for effective descaling.

In some implementations, the hybrid tool assembly 110 includes a control system 122 which is functionally coupled to the acid jetting subassembly 150, the water jetting subassembly 160, the gas purge subassembly 170, the laser subassembly 180 and/or the rotator subassembly 190. The control system 122 can include a computer-readable medium (e.g., a non-transitory computer-readable medium) storing computer instructions executable by one or more processors. The one or more processors can execute the stored computer instructions to perform operations described in this disclosure. The control system 122 can be configured to manage and coordinate the sequence of operations performed by these subassemblies. For example, the control system 122 can manage power distribution to individual subassemblies. This can involve directing a power source to supply energy to each subassembly as needed. Therefore, the control system can regulate the operation of these subassemblies based on a predetermined operation sequence.

In some implementations, the assembly head body 120 includes a camera which is configured to visualize the scales 104 inside the pipeline 102. This camera can facilitate identifying the volume and types of scales 104, thus assisting in the selection of appropriate descaling methods tailored to the specific scale types. Furthermore, by assessing the volume of scales 104 prior to operation, the camera enables the determination of a required operating power for the descaling process. This proactive approach mitigates the risk of incomplete scale removal, which could potentially result in tool entrapment in the scales 104.

In operation, the assembly head body 120 can be inserted into a vertical pipeline using coiled tubing. For a horizontal pipeline 102, the assembly head body 120 can be deployed at the inlet or the outlet of the pipeline 102. In some implementations, a robot or crawler is deployed to carry the assembly head body 120 inside a horizontal pipeline 102. The robot or crawler can include tracks or wheels to navigate through the interior of the pipeline 102. The movement of the robot or crawler can be controlled remotely by the control system 122. The robot or crawler can further include a camera to visualize the scales 104 inside the pipeline 102. In some implementations, to descale lengthy horizontal pipelines, openings or doors are formed in the middle section of the pipeline wall into which the assembly head body 120 can be inserted.

FIGS. 2A-2C illustrates various embodiments of the bottom surfaces 108 of the assembly head body 120. As illustrated in FIG. 2A, multiple acid jetting openings 202 on the bottom surface 108 are arranged with a wavy pattern along a quasi-radial direction. A wavy pattern can be an elongated and non-straight line with wave-like design, as shown. Likewise, the water jetting openings 204 on the bottom surface 108 can also be arranged with a similar wavy pattern parallel to the acid jetting openings 202. Each acid jetting opening 202 or water jetting opening 204 can have a circular shape or other suitable shapes. As noted above, different openings are the endpoints of internal flow pathways that are at least partially located within the assembly head body. The pathways are channels or conduits configured to guide the flow of various fluids through the assembly head body 120, as illustrated in FIGS. 1B-1C.

In some implementations, the acid jetting openings include at least one edge acid jetting opening (e.g., 202a and/or 202b) adjacent an edge of the bottom surface 108. In operation, referring to FIG. 1B, the edge of the bottom surface 108 can be close to the recently descaled exposed inner surfaces 148 of pipelines 102. Acids from the edge acid jetting openings (e.g., 202a and/or 202b) have a heightened risk of splashing onto these exposed inner surfaces 148, potentially leading to erosion and compromising the structural integrity of the pipelines 102. To mitigate this risk, returning to FIG. 2A, at least one water jetting opening (e.g., 204a, and/or 204b) can be positioned between the edge of the bottom surface 108 and the edge acid jetting opening (e.g., 202a and/or 202b). This configuration can lower the acid concentration by facilitating the mixing of acid and water, thereby reducing the likelihood of acid corrosion on the exposed inner surfaces 148.

Between the acid jetting openings 202 and water jetting openings 204, a laser opening 208 can be positioned to allow a laser beam 124 passing through, as illustrated in FIG. 2A. The laser beam 124 can be configured to have an elongated shape with similar wavy pattern as the acid jetting openings 202 or the water jetting openings 204. In addition, multiple gas purge openings 206 are arranged alongside the laser opening 208 to purge gas for clearing the debris or cuttings that block the path of the laser beam 124. The gas purge openings 206 can have a rectangular shape (as shown) or other suitable shape.

FIG. 2B illustrates another example bottom surface 108 of an assembly head body 120. As shown, the acid jetting openings 202, the water jetting openings 204 and the laser opening 208 can have a liner shape or a straight-line shape along a diameter or a quasi-diameter direction. The laser opening 208 can pass through the center of the bottom surface 108. One or more gas purge openings 206 can be arranged along one side of the laser opening 208. This arrangement can help simplify the design complexity of mechanical connections between different fluid tubing or conduits and their respective openings on the bottom surface 108 of the assembly head body 120.

FIG. 2C illustrates another example bottom surface 108 of an assembly head body 120. The acid jetting openings 202 are arranged along a first direction R1 on the bottom surface 108 of the assembly head body 120, while the water jetting openings 204 are arranged along a second direction R2 and the laser opening 208 is arranged along a third direction R3. The R1, R2 and R3 directions can be radial directions that pass through the center of the bottom surface 108. In contrast to examples in FIGS. 2A and 2B, the R1, R2 and R3 directions can intersect with each other. The gas purge openings 206 can be arranged in the region between any two types of openings as show in FIG. 2C. This configuration facilitates better mixture of different fluids, e.g., acid and water, during descaling operations, thus contributing to a more uniform descaling across the scales 104.

Although not shown in FIGS. 2A-2C, it is understood that the bottom surface 108 can have any other suitable shape other than the round shape. For example, the bottom surface 108 can have a square, rectangle, ellipse, or irregular shape. It is further understood that various openings can have any other suitable shapes (e.g., square, rectangle, or irregular shape) with any other suitable arrangements.

In some implementations, check valves are attached in the acid jetting openings 202, water jetting openings 204 and/or gas purge openings 206. Check valves are on-way valves which are configured to allow the flow of fluid in one direction, e.g., from the hybrid tool assembly 110 to the pipeline 102, while preventing reverse flow or backflow. Check valves can protect the hybrid tool assembly 110 from damage or contamination caused by backflow or pressure surges. Check valves can include swing check valves, lift check valves, and/or ball check valves.

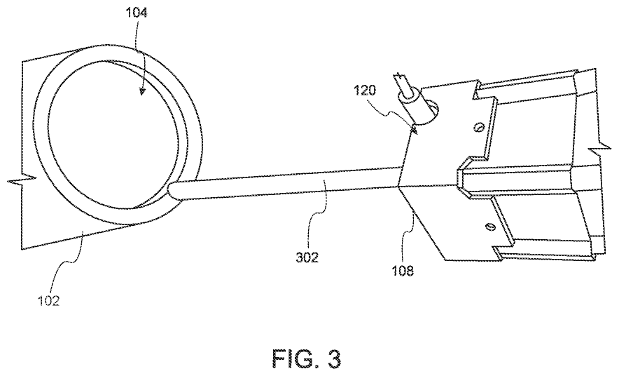

In some implementations, one or more nozzles are mechanically attached in the acid jetting openings 202, water jetting openings 204 or gas purge openings 206 on the bottom surface 108 of the assembly head body 120. The nozzles can be connected to the corresponding tubing, conduit or lines to control and direct the flow of acid, water and/or gas into the pipeline 102. In some implementations, the nozzles are elongated, extending outward from the assembly head body 120. FIG. 3 illustrates an example assembly head body 120 with an elongated gas purge nozzle 302. In some cases, the elongated gas purge nozzle 302 can deliver a more focused and directed stream of gas to clear the paths for laser or other fluids by removing the cuttings and debris. It also enables better access to narrow, confined or hard-to-reach scales areas. Because the elongated gas purge nozzle 302 extends outward from the bottom surface 108, it can reduce interference between gas and other fluid (e.g., acid or water) jetting from this bottom surface 108. It is understood that other types of nozzles, e.g., water nozzle, acid nozzles, can also have similar elongated shapes.

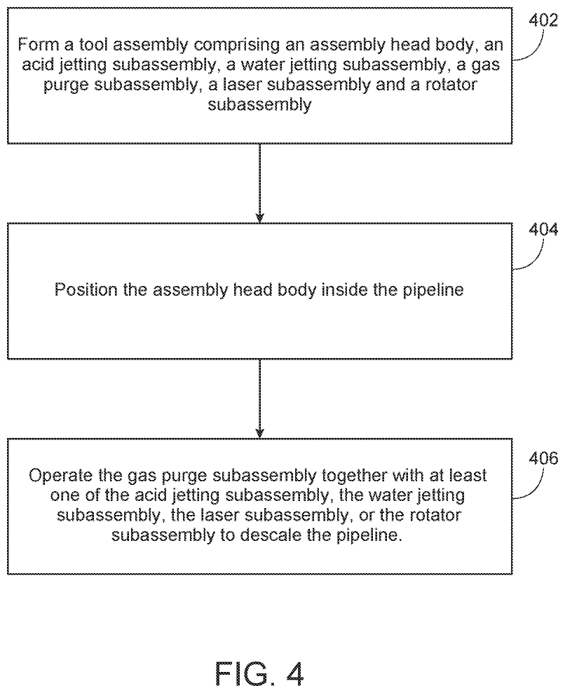

FIG. 4 is a flow chart of an example process to descale a pipeline 102. At step 402, a hybrid tool assembly 110 is formed. The hybrid tool assembly 110 includes an assembly head body 120, an acid jetting subassembly 150, a water jetting subassembly 160, a gas purge subassembly 170, a laser subassembly 180 and a rotator subassembly 190. As described above in FIGS. 1-3, the assembly head body 120 includes a bottom surface 108. The bottom surface 108 defines an acid jetting opening 202, a water jetting opening 204, a gas purge opening 206 and a laser opening 208. The acid jetting subassembly 150 is configured to jet acid out of the assembly head body 120 through the acid jetting opening 202. The water jetting subassembly 160 is configured to jet water out of the assembly head body 120 through the water jetting opening 204. The gas purge subassembly 170 is configured to purge gas out of the assembly head body 120 through the gas purge opening 206. The laser subassembly 180 is configured to generate a laser beam 124 passing through the laser opening 208. The rotator subassembly 190 is configured to rotate the assembly head body 120. As noted above, the selection of descaling methods can depend on the composition or natures of the scales 104.

At step 404, the assembly head body 120 is positioned inside the pipeline 102. The assembly head body 120 can be configured to move into and out of the pipelines 102. The movement of the assembly head body 120 can be realized with an electrical motor.

At step 406, the gas purge subassembly 170 is operated together with at least one of the acid jetting subassembly 150, the water jetting subassembly 160, the laser subassembly 180, or the rotator subassembly 190 to descale the pipeline 102. The gas purge subassembly 170 can be configured to work simultaneously or sequentially with any other subassemblies. Any two of these subassemblies can be configured to work simultaneously.

### Implementations

Certain aspects of the subject matter described here can be implemented as a hybrid tool assembly to descale a pipeline. The hybrid tool assembly includes an assembly head body, an acid jetting subassembly, a water jetting subassembly, a gas purge subassembly and a laser subassembly. The assembly head body includes a bottom surface defining an acid jetting opening, a water jetting opening, a gas purge opening and a laser opening. The acid jetting subassembly is fluidically coupled to the acid jetting opening and configured to jet acid out of the assembly head body through the acid jetting opening onto scales accumulated on an inner surface of the pipeline. The water jetting subassembly is fluidically coupled to the water jetting opening and configured to jet water out of the assembly head body through the water jetting opening onto the scales. The gas purge subassembly is fluidically coupled to the gas purge opening and configured to purge gas out of the assembly head body through the gas purge opening. The laser subassembly is functionally coupled to the laser opening and configured to generate a laser beam passing through the laser opening onto the scales. The gas purge subassembly is configured to operate together with at least one of the acid jetting subassembly, the water jetting subassembly or the laser subassembly to descale the pipeline.

An aspect combinable with any other aspect includes the following features. At least two of the acid jetting subassembly, the water jetting subassembly, the gas purge subassembly or the laser subassembly are configured to operate simultaneously.

An aspect combinable with any other aspect includes the following features. The gas purge subassembly is configured to operate simultaneously with the laser subassembly.

An aspect combinable with any other aspect includes the following features. The acid jetting subassembly is configured to operate simultaneously with the water jetting subassembly.

An aspect combinable with any other aspect includes the following features. The hybrid tool assembly includes a rotator subassembly configured to rotate the assembly head body.

An aspect combinable with any other aspect includes the following features. The rotator subassembly is configured to operate simultaneously with at least one of the acid jetting subassembly, the water jetting subassembly, the gas purge subassembly, or the laser subassembly.

An aspect combinable with any other aspect includes the following features. The bottom surface of the assembly head body defines a plurality of acid jetting openings. The plurality of acid jetting openings includes the acid jetting opening. The plurality of acid jetting openings is arranged with a wavy or linear pattern on the bottom surface.

An aspect combinable with any other aspect includes the following features. The plurality of acid jetting openings includes an edge acid jetting opening adjacent an edge of the bottom surface. The water jetting opening is positioned between the edge of the bottom surface and the edge acid jetting opening.

An aspect combinable with any other aspect includes the following features. The bottom surface of the assembly head body defines a plurality of water jetting openings. The plurality of water jetting openings includes the water jetting opening. The plurality of water jetting openings is arranged with a wavy or linear pattern on the bottom surface.

An aspect combinable with any other aspect includes the following features. The laser opening has an elongated shape.

An aspect combinable with any other aspect includes the following features. The gas includes pressurized nitrogen or air.

Certain aspects of the subject matter described here can be implemented as hybrid tool assembly to descale a pipeline. The hybrid tool assembly includes an assembly head body, an acid jetting subassembly, a water jetting subassembly, a gas purge subassembly, a laser subassembly and a rotator subassembly. The assembly head body includes a bottom surface defining an acid jetting opening, a water jetting opening, a gas purge opening and a laser opening. The acid jetting subassembly is fluidically coupled to the acid jetting opening and configured to jet acid out of the assembly head body through the acid jetting opening onto scales accumulated on an inner surface of the pipeline. The water jetting subassembly is fluidically coupled to the water jetting opening and configured to jet water out of the assembly head body through the water jetting opening onto the scales. The gas purge subassembly is fluidically coupled to the gas purge opening and configured to purge gas out of the assembly head body through the gas purge opening. The laser subassembly is functionally coupled to the laser opening and configured to generate a laser beam passing through the laser opening onto the scales. The rotator subassembly is configured to rotate the assembly head body along an axial direction.

An aspect combinable with any other aspect includes the following features. The gas purge subassembly is configured to operate simultaneously with at least one of the acid jetting subassembly, the water jetting subassembly or the laser subassembly.

An aspect combinable with any other aspect includes the following features. The gas purge subassembly is configured to operate sequentially with the laser subassembly.

An aspect combinable with any other aspect includes the following features. the bottom surface of the assembly head body defines a plurality of acid jetting openings. The plurality of acid jetting openings includes the acid jetting opening. The plurality of acid jetting openings is arranged with a wavy or linear pattern along a first direction on the bottom surface.

An aspect combinable with any other aspect includes the following features. The bottom surface of the assembly head body defines a plurality of water jetting openings. The plurality of water jetting openings includes the water jetting opening. The plurality of water jetting openings is arranged with a wavy or linear pattern along a second direction on the bottom surface.

An aspect combinable with any other aspect includes the following features. The second direction intersects with the first direction.

Certain aspects of the subject matter described here can be implemented as a method to descale a pipeline. The method includes forming a hybrid tool assembly which includes an assembly head body, an acid jetting subassembly, a water jetting subassembly, a gas purge subassembly, a laser subassembly and a rotator subassembly. The assembly head body includes a bottom surface defining an acid jetting opening, a water jetting opening, a gas purge opening and a laser opening. The acid jetting subassembly is configured to jet acid out of the assembly head body through the acid jetting opening. The water jetting subassembly is configured to jet water out of the assembly head body through the water jetting opening. The gas purge subassembly is configured to purge gas out of the assembly head body through the gas purge opening. The laser subassembly is configured to generate a laser beam passing through the laser opening. The rotator subassembly is configured to rotate the assembly head body. The method further includes positioning the assembly head body inside the pipeline. The method also includes operating the gas purge subassembly together with at least one of the acid jetting subassembly, the water jetting subassembly, the laser subassembly, or the rotator subassembly to descale the pipeline.

An aspect combinable with any other aspect includes the following features. Operating the gas purge subassembly together with at least one of the acid jetting subassembly, the water jetting subassembly, the laser subassembly, or the rotator subassembly to descale the pipeline includes: operating the gas purge subassembly and the laser subassembly simultaneously or sequentially.

An aspect combinable with any other aspect includes the following features. Operating the gas purge subassembly together with at least one of the acid jetting subassembly, the water jetting subassembly, the laser subassembly, or the rotator subassembly to descale the pipeline includes: operating the water jetting subassembly and the acid jetting subassembly simultaneously.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Moreover, aspects described with reference to any figure or any implementation can be combined with aspects described with any other figure or any other implementation.

It is understood that the articles “a,” “an,” and “the” in this disclosure are intended to mean that there are one or more of the elements in the preceding descriptions. The terms “comprising,” “including,” and “having” are intended to be inclusive and mean that there may be additional elements other than the listed elements. Additionally, it should be understood that references to “one example” or “an example” of the present disclosure are not intended to be interpreted as excluding the existence of additional examples that also incorporate the recited features. For example, any element described in relation to an example herein may be combinable with any element of any other example described herein. Numbers, percentages, ratios, or other values stated herein are intended to include that value, and also other values that are “about” or “approximately” the stated value, as would be appreciated by one of ordinary skill in the art encompassed by examples of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to examples disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the examples that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

1. A hybrid tool assembly to descale a pipeline, the hybrid tool assembly comprising:
an assembly head body comprising a bottom surface defining an acid jetting opening, a water jetting opening, a gas purge opening and a laser opening;
an acid jetting subassembly fluidically coupled to the acid jetting opening and configured to jet acid out of the assembly head body through the acid jetting opening onto scales accumulated on an inner surface of the pipeline;
a water jetting subassembly fluidically coupled to the water jetting opening and configured to jet water out of the assembly head body through the water jetting opening onto the scales;
a gas purge subassembly fluidically coupled to the gas purge opening and configured to purge gas out of the assembly head body through the gas purge opening; and
a laser subassembly functionally coupled to the laser opening and configured to generate a laser beam passing through the laser opening onto the scales,
wherein the gas purge subassembly is configured to operate together with at least one of the acid jetting subassembly, the water jetting subassembly or the laser subassembly to descale the pipeline.

2. The hybrid tool assembly of claim 1, wherein at least two of the acid jetting subassembly, the water jetting subassembly, the gas purge subassembly or the laser subassembly are configured to operate simultaneously.

3. The hybrid tool assembly of claim 1, wherein the gas purge subassembly is configured to operate simultaneously with the laser subassembly.

4. The hybrid tool assembly of claim 1, wherein the acid jetting subassembly is configured to operate simultaneously with the water jetting subassembly.

5. The hybrid tool assembly of claim 1, further comprising a rotator subassembly configured to rotate the assembly head body.

6. The hybrid tool assembly of claim 5, wherein the rotator subassembly is configured to operate simultaneously with at least one of the acid jetting subassembly, the water jetting subassembly, the gas purge subassembly, or the laser subassembly.

7. The hybrid tool assembly of claim 1, wherein the bottom surface of the assembly head body defines a plurality of acid jetting openings, the plurality of acid jetting openings comprising the acid jetting opening, the plurality of acid jetting openings being arranged with a wavy or linear pattern on the bottom surface.

8. The hybrid tool assembly of claim 7, wherein the plurality of acid jetting openings comprises an edge acid jetting opening adjacent an edge of the bottom surface, and the water jetting opening is positioned between the edge of the bottom surface and the edge acid jetting opening.

9. The hybrid tool assembly of claim 1, wherein the bottom surface of the assembly head body defines a plurality of water jetting openings, the plurality of water jetting openings comprising the water jetting opening, the plurality of water jetting openings being arranged with a wavy or linear pattern on the bottom surface.

10. The hybrid tool assembly of claim 1, wherein the laser opening has an elongated shape.

11. The hybrid tool assembly of claim 1, wherein the gas comprises pressurized nitrogen or air.

12. A hybrid tool assembly to descale a pipeline, the hybrid tool assembly comprising:
an assembly head body comprising a bottom surface defining an acid jetting opening, a water jetting opening, a gas purge opening and a laser opening;
an acid jetting subassembly fluidically coupled to the acid jetting opening and configured to jet acid out of the assembly head body through the acid jetting opening onto scales accumulated on an inner surface of the pipeline;
a water jetting subassembly fluidically coupled to the water jetting opening and configured to jet water out of the assembly head body through the water jetting opening onto the scales;
a gas purge subassembly fluidically coupled to the gas purge opening and configured to purge gas out of the assembly head body through the gas purge opening;
a laser subassembly functionally coupled to the laser opening and configured to generate a laser beam passing through the laser opening onto the scales; and
a rotator subassembly configured to rotate the assembly head body along an axial direction.

13. The hybrid tool assembly of claim 12, wherein the gas purge subassembly is configured to operate simultaneously with at least one of the acid jetting subassembly, the water jetting subassembly or the laser subassembly.

14. The hybrid tool assembly of claim 12, wherein the gas purge subassembly is configured to operate sequentially with the laser subassembly.

15. The hybrid tool assembly of claim 12, wherein the bottom surface of the assembly head body defines a plurality of acid jetting openings, the plurality of acid jetting openings comprising the acid jetting opening, the plurality of acid jetting openings being arranged with a wavy or linear pattern along a first direction on the bottom surface.

16. The hybrid tool assembly of claim 15, wherein the bottom surface of the assembly head body defines a plurality of water jetting openings, the plurality of water jetting openings comprising the water jetting opening, the plurality of water jetting openings being arranged with a wavy or linear pattern along a second direction on the bottom surface.

17. The hybrid tool assembly of claim 16, wherein the second direction intersects with the first direction.

18. A method to descale a pipeline, the method comprising:
forming a hybrid tool assembly comprising an assembly head body, an acid jetting subassembly, a water jetting subassembly, a gas purge subassembly, a laser subassembly and a rotator subassembly, the assembly head body comprising a bottom surface defining an acid jetting opening, a water jetting opening, a gas purge opening and a laser opening, the acid jetting subassembly configured to jet acid out of the assembly head body through the acid jetting opening, the water jetting subassembly configured to jet water out of the assembly head body through the water jetting opening, the gas purge subassembly configured to purge gas out of the assembly head body through the gas purge opening, the laser subassembly configured to generate a laser beam passing through the laser opening, the rotator subassembly configured to rotate the assembly head body;
positioning the assembly head body inside the pipeline; and
operating the gas purge subassembly together with at least one of the acid jetting subassembly, the water jetting subassembly, the laser subassembly, or the rotator subassembly to descale the pipeline.

19. The method of claim 18, wherein operating the gas purge subassembly together with at least one of the acid jetting subassembly, the water jetting subassembly, the laser subassembly, or the rotator subassembly to descale the pipeline comprises:
operating the gas purge subassembly and the laser subassembly simultaneously or sequentially.

20. The method of claim 18, wherein operating the gas purge subassembly together with at least one of the acid jetting subassembly, the water jetting subassembly, the laser subassembly, or the rotator subassembly to descale the pipeline comprises:
operating the water jetting subassembly and the acid jetting subassembly simultaneously.
